(19) United States
(12) Patent Application Publication
(10) Pub. No.: US 2009/0070316 A1
(43) Pub. Date: Mar. 12, 2009

(54) WEB-BASED SUCCESSION PLANNING

(76) Inventors: Christian Beauchesne, Orleans (CA); Deborah Wilson, Ottawa (CA); Dawn Mackay, Ottawa (CA)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 11/859,468

(22) Filed: Sep. 21, 2007

Related U.S. Application Data
(60) Provisional application No. 60/970,825, filed on Sep. 7, 2007.

(51) Int. Cl. G06F 17/30

(52) U.S. Cl. 707/5; 707/E17.108

(57) ABSTRACT

A system and method are provided for providing web-based succession planning process. Through a web-based interface, pre-defined talent criteria is utilized to define talent pools retrieved from a database. Each criteria can then in turn have a weight value and a threshold value assigned to it. A gap threshold percentage is assigned to the talent pool. Succession criteria are then assigned from a pre-defined succession criteria database list based upon characteristics of a group of employees being assessed. Candidates for the talent pool are then determined from the group of employees based upon the assessed talent criteria score relative to the gap threshold of the talent pool, and the succession criteria scores for each of the employees from an employee assessment database. The candidates for the talent pool can then be displayed in an html viewer based upon the assessment score and succession criteria scores.

### CROSS-REFERENCE TO RELATED APPLICATIONS

This application claims priority from U.S. Provisional Application No. 60/970,825 filed on Sep. 7th, 2007, which application is incorporated herein by reference.

### TECHNICAL FIELD

The present invention relates to human resources management and in particular to a system and method for enabling web-based succession planning.

### BACKGROUND

As millions of baby boomers approach retirement age, employers are giving thought to replacing them with the best possible workers. In addition, employers need to focus on retaining their top performers as they are increasingly ready and willing to move companies for something better. The need to retain good employees is compounded by the retiring baby boomers that are projected to leave a huge talent gap because the lower number of new workers will not be able to fill the need. Planning for succession is an important aspect of human resources management and cannot be ignored. A succession strategy is being demanded by company boards and top executives to ensure that their companies will be able to survive and thrive through the crisis.

Unfortunately, attempts to automate succession planning to date have produced some of the poorest return on investments of all of the strategic human resource (HR) applications areas (for example, when compared to on-line appraisals and compensation applications). Existing successions systems have been too focused on naming specific successor for top jobs (replacement-planning) and the major metric by which succession systems are evaluated is the percentage of openings filled from within the firm, not necessarily finding the best fit for the position.

Current tools are expensive and complicated as they are: typically based on the organization chart replacement model; time consuming to administer; quickly out-of-date; result in duplication of effort; focused on too few individuals and are overwhelming and difficult to implement. Therefore current succession planning tools have ended up being expensive in terms of administration effort and overly complicated to manage. Current succession planning tools are based on a system to track successors, not to develop or retain them. These tools are primarily based on keeping an organizational chart up to date, which can be difficult and results in poor returns and they require input of data from performance management which are not readily implemented. In addition, as typical succession models focus exclusively on named successors to key positions, they ignore the potential that exists lower down in the ranks and alienated employees by concentrating on too few individuals.

Accordingly, new systems and methods that enable effective succession planning remain highly desirable.

### SUMMARY

In accordance with one aspect there is provided a method for performing web-based succession planning (SP), the method comprising the steps of: creating a talent pool and associating the talent pool with one or more talent criteria from a pre-defined competency database; assigning a weight value and a target value for each talent criteria associated to the talent pool; assigning a gap threshold percentage to the talent pool, wherein the gap threshold defines a differential between a current employee assessment and the talent criteria target value; assigning succession criteria from a pre-defined succession criteria database list based upon characteristics of a group of employees being assessed; retrieving assessed talent criteria scores and succession criteria scores for each employee of a group of employees from an employee assessment database; determining candidates from the group of employees for inclusion in the talent pool based upon the assessed talent criteria score relative to the gap threshold of the talent pool, and the succession criteria scores for each of the employees from an employee assessment database; and displaying the candidates suitable for inclusion in the talent pool based upon the assessment score and succession criteria scores.

In accordance with another aspect there is provided A web-based succession planning system comprising: a memory for storing databases; a processor for performing the steps of: creating a talent pool and associating the talent pool with one or more talent criteria from a pre-defined competency database stored in the memory; assigning a weight value and a target value for each talent criteria associated to the talent pool; assigning a gap threshold percentage to the talent pool, wherein the gap threshold defines a differential between a current employee assessment and the talent criteria target value; assigning succession criteria from a pre-defined succession criteria database list based upon characteristics of a group of employees being assessed; retrieving assessed talent criteria scores and succession criteria scores for each employee of a group of employees from an employee assessment database stored in the memory; determining candidates from the group of employees for inclusion in the talent pool based upon the assessed talent criteria score relative to the gap threshold of the talent pool, and the succession criteria scores for each of the employees from an employee assessment database stored in the memory; and displaying the candidates suitable for inclusion in the talent pool based upon the assessment score and succession criteria scores.

In accordance with yet another aspect there is provided computer readable medium containing instructions for performing web-based succession planning (SP), the instructions when executed by a processor perform the steps of: creating a talent pool and associating the talent pool with one or more talent criteria from a pre-defined competency database; assigning a weight value and a target value for each talent criteria associated to the talent pool; assigning a gap threshold percentage to the talent pool, wherein the gap threshold defines a differential between a current employee assessment and the talent criteria target value; assigning succession criteria from a pre-defined succession criteria database list based upon characteristics of a group of employees being assessed; retrieving assessed talent criteria scores and succession criteria scores for each employee of a group of employees from an employee assessment database; determining candidates from the group of employees for inclusion in the talent pool based upon the assessed talent criteria score relative to the gap threshold of the talent pool, and the succession criteria scores for each of the employees from an employee assessment database; and displaying the candidates suitable for inclusion in the talent pool based upon the assessment score and succession criteria scores.

Other aspects and features will become apparent to those ordinarily skilled in the art upon review of the following description in conjunction with the accompanying figures.

### BRIEF DESCRIPTION OF THE DRAWINGS

Further features and advantages will become apparent from the following detailed description, taken in combination with the appended drawings, in which:

FIG. 1 is a schematic representation of a succession planning system;

FIG. 2 is a process diagram for succession planning;

FIG. 3 is a schematic representation of a database for succession planning;

FIG. 4 is a method of succession planning;

FIG. 5 is a method of defining talent pools;

FIG. 6 is a method for performing performance assessment;

FIG. 7 is a method for collecting assessment data;

FIG. 8 is a method for identifying potential pool members;

FIG. 9 is an illustration of a high potential report;

FIG. 10 is a method for displaying a high potential report;

FIG. 11 is an illustration of a retention risk report;

FIG. 12 is a method for defining a talent assessment process;

FIG. 13 is a method performing a talent assessment process;

FIG. 14 is an illustration of a talent assessment report;

FIG. 15 is an illustration of a talent pool report.

It will be noted that throughout the appended drawings, like features are identified by like reference numerals.

### DETAILED DESCRIPTION

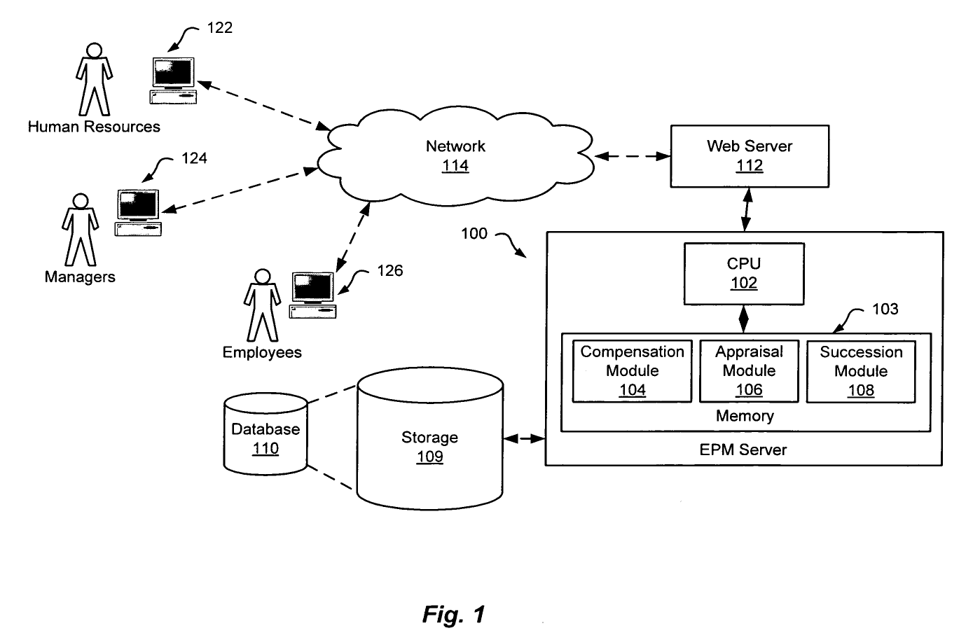

Embodiments are described below, by way of example only, with reference to FIGS. 1-15.

Succession planning using replacement (organization) charts has recently become outdated because it has produced a low return on investment. It also tends to ignore a significant portion of talent and potential that may be existing inside of the organization; when, in fact, this talent needs to be nurtured and retained in the face of a talent shortage.

The requirement for succession planning becomes increasingly more pressing as the size of a company increases. Traditional succession planning methodologies have not been effective at building internal talents pools from which to recruit successors for all key positions and not just the very top jobs. Defining talent pools can enable identification and promotion of people most likely to succeed within the organization. A change in the succession model enables an understanding of workforce potential and areas of retention risk. This facilitates proactive development of individual performance to address risk by growing successors from within. Succession requirements are more easily met with the right candidates from talent pools of people that are ready to meet the task. Key talent and potential inside the organization can then be maintained.

A practical and staged approach to succession planning is provided that not only supports the requirement for managing talent pools but also lets an organization get started quickly and then to progress in manageable steps toward the overall objective of managing for succession in an organization. This approach increases the probability that an organization will be successful in the long term execution of its plan.

Defining pools of key talent that are assessed against criteria to measure current performance and future potential enables “high potentials” to be monitored, measured and enables an understanding of the competencies required for fulfilling critical roles within the organization. When executive or other key positions become vacant, a number of suitable candidates are ready to step into the role from within the organization.

Managers can collect confidential succession planning data as a component of the performance management process, or a talent assessment process, and that data becomes a part of the employee's talent profile. The manager can assess and provide a prediction of the employee's overall potential—ultimately where the candidate may aspire to in the company, or whether they are currently too new to assess, already well placed or need development where they are. The estimated time it will take for that employee to reach their overall potential can also be provided. In addition a recommendation for career development by suggesting an employee become part of a talent pool as well as an indication of the risk that the employee will leave the company, when and why.

HR administrators are able define any number of talent pools and associate a competency model that is required for success within that pool. The system also supports a means to execute “talent assessments” for succession planning purposes. A new type of workflow allows individuals to be assessed against the definition of a talent pool. The individual may be a candidate for the talent pool or already a participant who is undergoing a planned re-assessment. The purpose of the assessment is to highlight the skill and competency ‘gaps’ between each individual and the ideal for the talent pool.

Manager ratings, self-ratings and multi-rater assessments are also supported and are important in determining whether an employee should join or be allowed to develop as part of a talent pool. Talent assessments are completed by an employee's manager, but may also be assigned to someone else more familiar with the competencies that define the talent pool. Like a performance appraisal, a talent assessment produces a document that can be saved and represents an employee's rating at a point in time. When a manager is executing a succession planning assessment he/she will be able to recall past assessments.

Once placed in a talent pool, an IDP (individual development plan) for the employee can be created that addresses the gaps between the requirements for the talent pool and capabilities of the employee. Over time, the employee will become a better and better match with the talent pool profile. Queries on the succession planning data can be used to find successors as needed with ranking, sorting and filtering capabilities that permit a succession manager to query the employee information in a manner that identifies the best candidates.

FIG. 1 is a schematic representation of a succession planning system. The employee performance management (EPM) server 100 comprises a computing device for retrieving, storing and processing data. The EPM server 100 may be implemented as computer software in the form of computer readable code executed.

The EPM server 100 comprises central processing unit (CPU) 102 and memory 103. The CPU may be a single processor or multiprocessor system. In various computing environments, main memory 103 and storage 109 can reside wholly in a computer environment, or they may be distributed between multiple computers.

The computer processor 102 or similar device may be programmed in the manner of method steps, or may be executed by an electronic system which is provided with means for executing these steps. The storage device 109 includes a database 110. The database may include both fixed and removable media, such as magnetic, optical or magnetic optical storage systems, Random Access Memory (RAM), Read Only Memory (ROM) or any other available mass storage technology. The storage device or media may be programmed to execute such method steps. As well, electronic signals representing these method steps may also be transmitted via a communication network.

The server 100 may comprise multiple human resource related software modules which reside in memory 103, for example a compensation module 104, appraisal module 106 and succession module 108. The compensation module 104 is utilized in monitoring and tracking employee compensation. The appraisal module 106 is utilized to define assessment criteria for evaluating employees and reviewing the data stored in relation to these employees. Finally a succession module 108 is used to determine employees that are candidates within defined talent pools. The software modules may reside on separate systems of within the same system. Additional human resources management software modules may also be provided. Each of the modules stores and retrieves data from a database 110. The database stores evaluation and succession criteria and collected data from the succession management workflow.

The succession management workflow is accessed by users of the system by a web server 112. The web server 112 generates and displays web pages in HTML, XML, JSP, JavaScript, DHTML, for entering and retrieving data based upon data provided from database 110. The web server 112 is accessed by a data network 114, which may be an internal network or an external network such as the internet. The web server interface enables collecting performance evaluation and succession planning data relating to determining potential for promotion, as well as talent pool recommendations relating to specific job competencies

The system is accessed by three main groups, human Resources 122, Managers 124 and Employees 126. Each of the groups may access the system by devices such as personal computers or notebook computers which provide a web enabled interface and can access network 114. Human Resources 122 defines the processes and workflows by which the evaluation of employees occurs. In addition Human Resources 122 defines criteria utilized in the process and utilizes processed data for providing recommendations regarding employees. The Managers 124 provides evaluation information in relation to the defined criteria for specific Employees 126 and also may be responsible for acting on the data provided in relation to promotion of individual Employees 126. Employees 126 provide input in the evaluation process, either in terms of self-evaluation or peer evaluation.

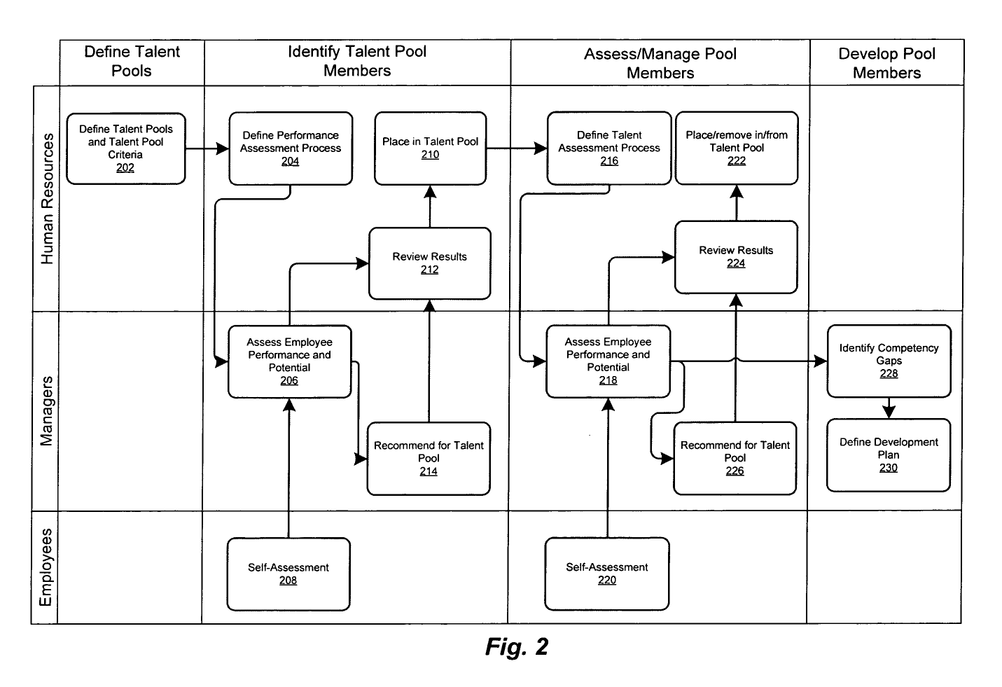

FIG. 2 is a high-level diagram showing a process for succession planning. Human Resources (HR) personnel define talent pools to be developed for the company 202. Each of the talent pools is further defined by a set of talent pool criteria 202. Once the talent pools are well defined, they need to be populated with talent. This talent needs to be identified through a performance assessment process. HR defines a performance assessment process that gathers the necessary data to identify pool talent pool candidates 204. Through this web-based performance assessment process, the line managers assess the employee's performance, potential for promotion and other succession planning criteria 206. Meanwhile, the employee may also be required to complete a self-assessment of his/her performance 208. This self-assessment data is available for the manager to view as part of the performance assessment process. As part of the performance assessment, the manager may also make a recommendation for the inclusion of the employee in a specific Talent Pool 214. HR retrieves these assessment results 212, and based on them and the manager recommendations, places employee in appropriate pool(s) 210.

Once candidate talent has been identified for each talent pool, this talent must be periodically assessed against the talent criteria defined for the pool. HR defines a talent assessment process that will be used to gather the necessary talent and succession criteria data to assess pool members and identify new talent pool candidates 216. Through this web-based talent assessment process, the line managers assess the employee against the talent criteria for the pool, and also the defined succession planning criteria for the talent assessment process 218. Meanwhile, the employee may also be required to complete a self-assessment of his/her performance 220. This self-assessment data is available for the manager to view as part of the talent assessment process. The manager also makes a recommendation for the inclusion (or removal) of the employee in (from) a specific Talent Pool 226. HR retrieves and reviews these talent assessment results 224, and based on them and the manager recommendations, adjusts the talent pool members accordingly 222.

As part of the talent assessment process, the manager also identifies gaps between the employee's current assessment and the target for each talent criteria for the Talent Pool 228. Based on this identification, the manager defines an individual development plan for the employee in order to improve specific talent pool criteria 230.

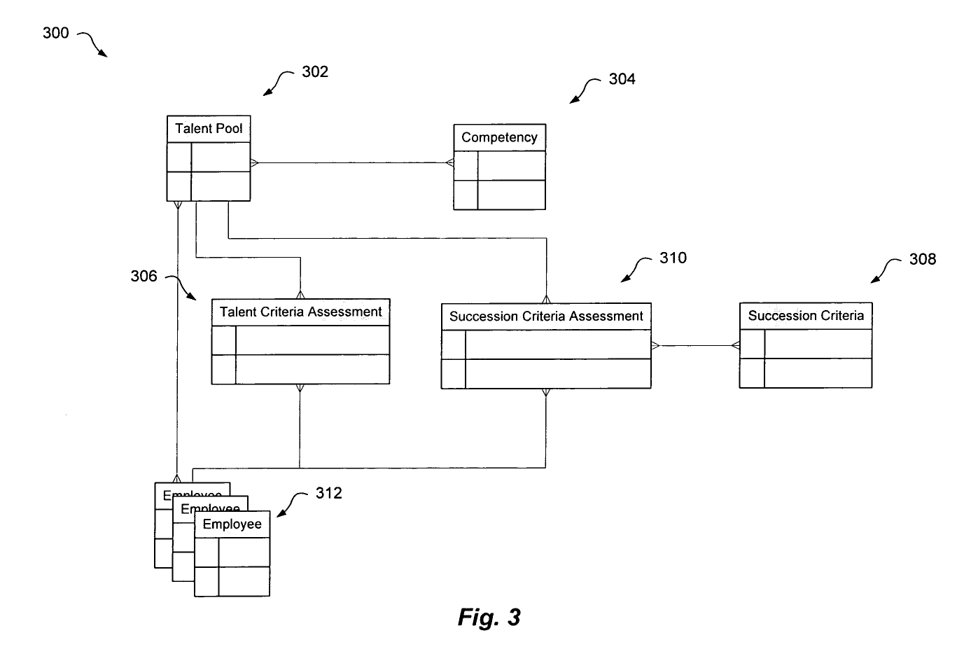

FIG. 3 is an example of the database structure and some exemplary tables. The database is a relational database such as Oracle™ or Microsoft™ SQL Server Each Talent Pool 302 is defined by a set of talent criteria made up of competencies coming for the competency library table 304. Employees 312 are assessed against Talent Pool criteria 306 and Succession Planning criteria 310. The succession planning criteria for the assessment are defined from a succession planning criteria library table 308. Nominated employees are included in the Talent Pool 302. Talent Pools 302 may include a pool title and description; talent pool competency gap threshold (%); a list of competencies associated with talent pool; target rating and weight for each competency; and a list of talent pool members. This data may be comprised by a single or multiple interrelated tables.

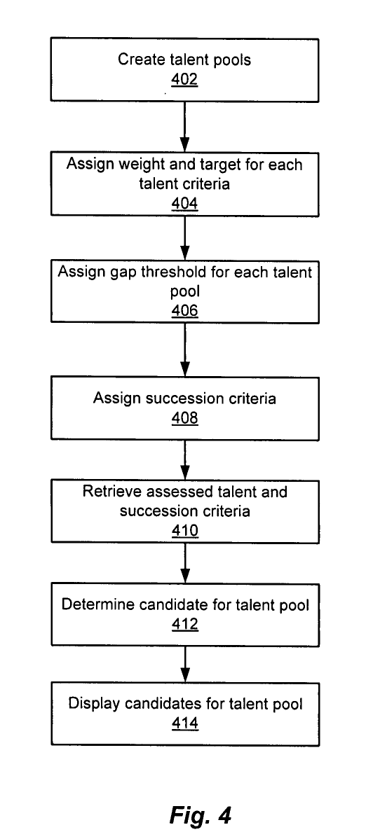

FIG. 4 is a method of succession planning. The succession planning process commences with talent pools being defined and created at step 402. The talent pools may be based upon job position, such as programmer or engineer; skill level index; or management level such as manager, director, vice president etc. Talent criteria must then be assigned with the talent pool at step 404. The talent criteria may be defined relative to competency associated with the pool. The competencies may be: Analytical Thinking, Project Management, Communication, or Negotiation Skills. A weight value to each competency can then be provided. For example communication skills may have a higher value in the pool compared to negotiation skills and would therefore be weighted appropriately. A target value for the skill can also be defined. This target value can be an assessment score for the ideal candidate. For example a 4.0 out of 5.0 for communication skill may be the target score. A gap threshold is then assigned at step 406, the gap threshold is utilized to identify variances for criteria scores relative to target scores, this defines a range of values relative to the target score for which a candidate can be admitted to the pool. The gap is defined as a percentage of variance. At step 408 succession criteria for the pool is then assigned. The criteria may be aspects such as potential for promotion, timing for promotion, risk of leaving, reason for leaving. Once the talent pool has been defined assessment and succession data can be retrieved at step 410. At step 412 using the data potential candidates for the talent pool can then be determined. At step 414 the talent pool and the candidates for the pool can then be displayed by an HTML page identifying candidates with the highest potential for succession with the organization for a particular role. Aspects of each step will be further defined.

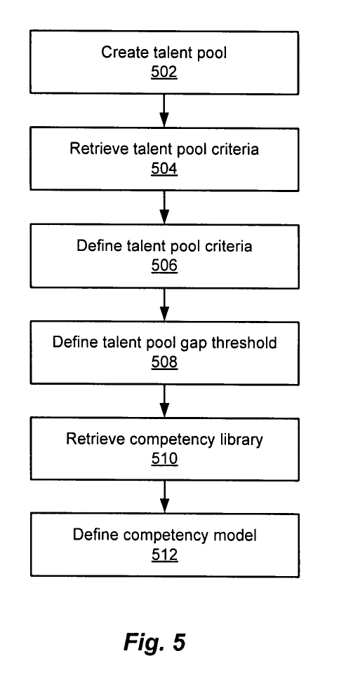

FIG. 5 is a method of defining talent pools. First, the HR admin or succession manager needs to define the talent pools. This is done in the succession module of the EPM suite. The pool is given a name and a narrative description. As noted above the talent pool is created and identified relative to a job position, skill level or management level though it may be by any number of definable job related criteria. The talent pool data is then retrieved at step 504 from criteria pre-defined by human resources manager. Criteria specific to the talent pool is then selected at step 506 and associated with the particular pool. The pool is given a gap threshold to help identify how close/far the employee's rating to each competency in the pool at step 508. The threshold may be a percentage of absolute value. A competency model is then established by talent pool considering the positions that will be fed by that pool. This competency model is defined using the EPM competency library and retrieved at step 510. The competencies may include talent criteria but not be limited to assessment factors such as communication, leadership, delegation, integrity and trust and organization. Each of the competencies may be rated with a numeric value or against a range of descriptive definitions related to performance against the competency which is in turn associated with a value. Each competency is given a target rating and a weight within each pool. The competency associated with the talent pool is then defined at step 512. Defining the model can include associating a target rating in addition to an overall weighting for each competency. The total weighting for all the competencies associated to the talent pool should equal 100%.

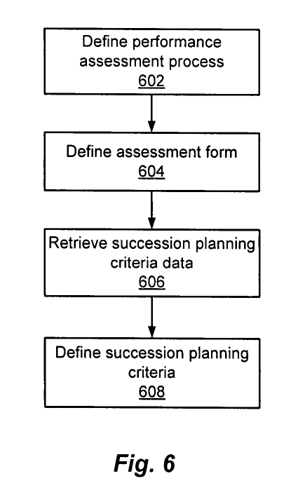

FIG. 6 is a method for performing performance assessment. In order to identify the members of the pool, HR creates a performance assessment process at step 602. The definition of the process involves defining the steps required to collect and validate the data. For example steps required to perform the assessment process such as: employee writes self performance assessment; HR approves self performance assessment; manager writes performance assessment; second level manager approves performance assessment; manager meets with employee; employee add final comments; and HR rep sign off. A number of days or target dates can be defined next to each step to enable the workflow to be tracked. Steps may be defined as occurring sequentially or concurrently within the evaluation process. An assessment form is defined, at step 604, this is done using the appraisal module that is part of the EPM suite. At step 606 succession planning criteria is retrieved from the database. Succession planning information is added to the assessment form at step 608 by defining the relevant succession criteria. Criteria may be utilized such as: potential for promotion, timing for next promotion, risk of leaving, reason for leaving. HR also can include a criterion that enables managers to make recommendations for employee inclusion into a talent pool. Through EPM's web-based workflow, managers complete the performance assessment form. They also complete the succession planning criteria presented, and make a recommendation for inclusion in talent pool(s), if that criterion is present.

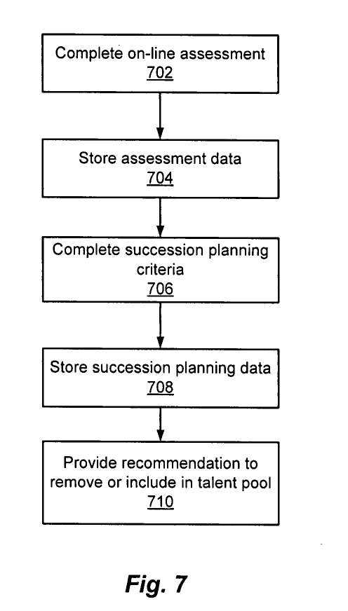

Once the process is defined data can be collected against the desired criteria. As shown in FIG. 7 a method for collecting assessment data started with managers and employees performing an online assessment at step 702 by providing data relative to the defined assessment criteria. The completed assessment data would then be stored at step 704. The employees may only be provided with a subset of criteria to provide input while the managers would have be provided with additional criteria such as succession data at step 706 which would then be stored in the database at step 708. A talent assessment form is automatically generated and presented to the manager with employee competencies to be rated. The manager can then provide recommendations at step 710 as to inclusion of a particular employee in a pool. The recommendation may be defined as keep in pool, recommend for pool, recommend for removal from pool.

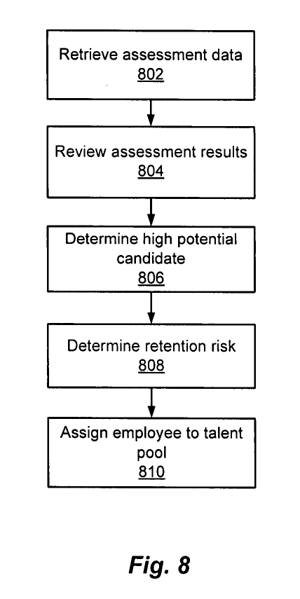

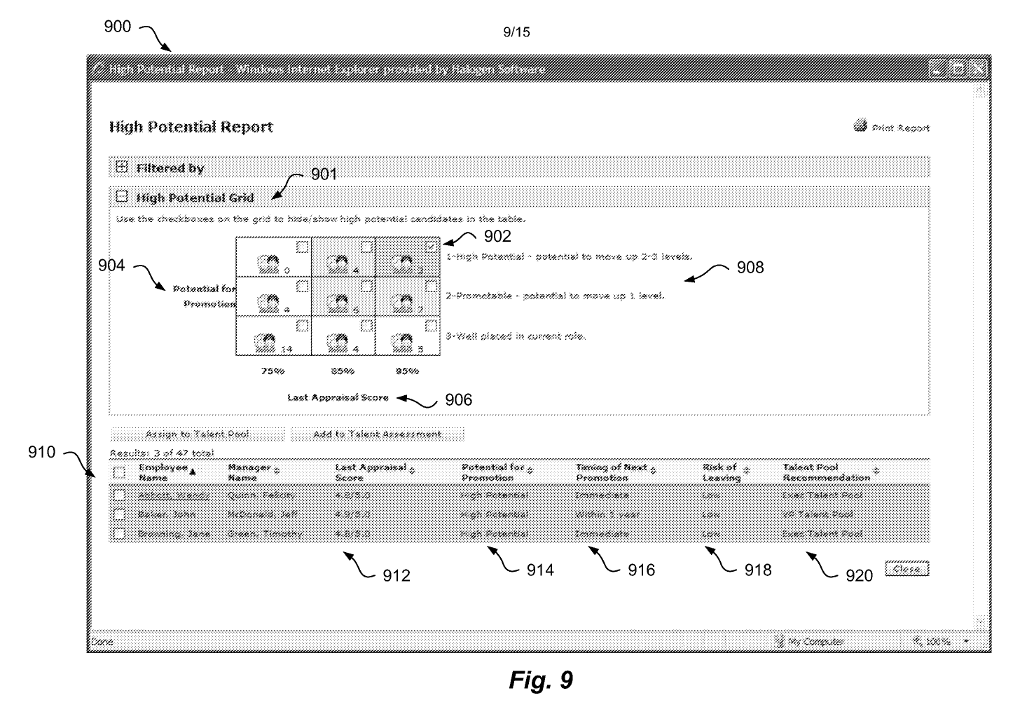

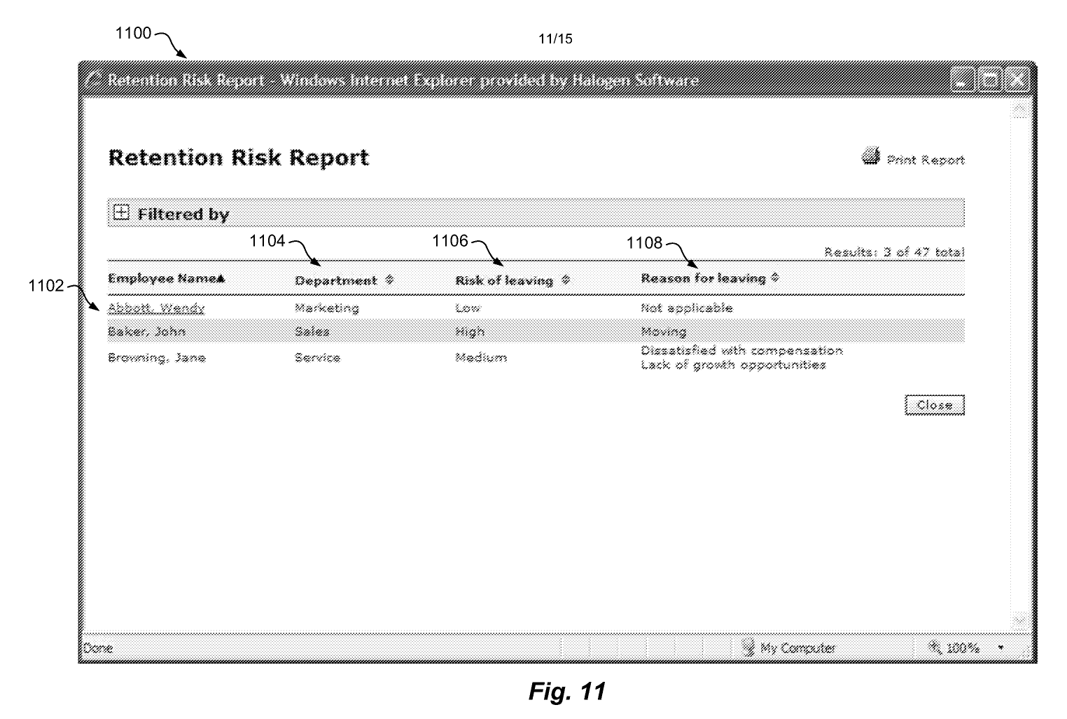

Once the performance assessment is complete, as shown in FIG. 8, HR can retrieve the assessment data from the database at step 802 and review the results at 804. High potential candidates for inclusion in the talent pool can then be determined at step 806. High potential candidates are candidates that meet the assessment criteria and succession criteria within the defined gap ranges. Candidates can be identified in a tabular format or in a graphical format as shown in FIG. 9. Risk retention can then be determined at step 808. The risk retention is based upon criteria assessed by the manager. Again, the report may be provided in a tabular format as shown in FIG. 11.

As shown in FIG. 9, report 900 is generated in web format based upon the retrieved data. The report plots each employee according to the key ratings of performance score and manager-assessed potential rating in a nine-box grid 901 and identifies “high potentials” and lets the viewer drill down into the employee details such as performance score, potential rating, next promotion and timing, career development recommendation, and risk of leaving. This report can be used for identifying the best internal candidates for development, or to find potential candidates for an immediate succession requirement. Candidates are ranked by defining each tier (x and y axis) of the grid by identifying range of “potential for promotion” 904 for each tier (y axis) and range of evaluation scores 906 for each tier (x axis). This results in rankings 908 of high potential, promotable or well placed. The report may also include a table 910 which identifies individual employees who are potential to be included in the talent pool. The grid can be color coded for ease of view relative to the grid. When a group of candidates are selected within the grid the are displayed within the table. The table can show further details for each employee such as the last appraisal score 912, the potential for promotion 914, the target for next promotion 916, risk for leaving 918, and talent pool recommendation 920. The report displays the number of high potential candidates in a green box, and detailed listing is provided as well. Based on the information displayed, including recommendations provided by the manager, HR can assign an employee to a pool.

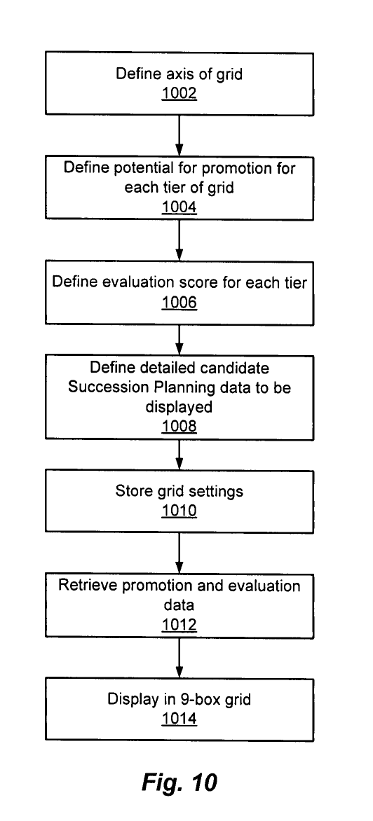

FIG. 10 is a method for displaying a high potential report 901. Aggregate data can be displayed in a 9-box grid showing total number of candidate in each box of the grid. Pre-select top-right box (top score range and top potential for promotion range. At step 1002 the grid is defined by defining each tier (x and y axis) of the 9-box grid. At step 1004 the range of “potential for promotion” response data for each tier (y axis) is defined. The range of evaluation score for each tier (x axis) is defined at step 1006. Detailed candidate SP data (report columns) to be displayed on grid report at step 1008. At step 1010 the grid settings are stored in the database. Promotion and evaluation data is retrieved from database based on grid settings at step 1012. The aggregate data in 9-box grid can then be displayed at step 1014 showing total number of candidate in each box of the grid.

FIG. 11 is an illustration of a retention risk report 1100. The retention risk report 1100 is a tool for succession management that helps to identify and then mitigate risk and can be run at any time on all employees or a particular group. A report for succession managers delivers an understanding of where there is risk of losing key employees and to identify areas where there may be a potential talent shortage, unless the risk is managed. The report identifies the employee 1102, the department 1104, the risk of leaving 1106 based upon a defined criteria from the manager and a reason for leaving 1108. The report is generated based upon manager assessment data acquired during the performance or talent assessment process.

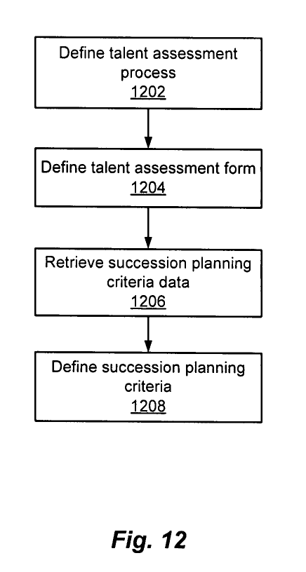

FIG. 12 is a method for defining talent assessment process. HR defines which employees will be assessed in the talent assessment process at step 1202. HR can assess specific pools and/or specific employees. A talent assessment form is defined at step 1204, and to that form a special section that pertains to succession planning is provided. In this section HR defines what succession criteria they want rated from a selection of criteria retrieved from the database at step 1206. Criteria such as: potential for promotion, timing for next promotion, risk of leaving, reason for leaving can then be selected for inclusion at step 1208. HR also can include a criterion that enables manager to make recommendations for employee inclusion into a talent pool. Also a section on this form provides all of the competencies that are being assessed. These competencies are dynamically defined based on the employees being assessed, and the talent pool they are being assessed against.

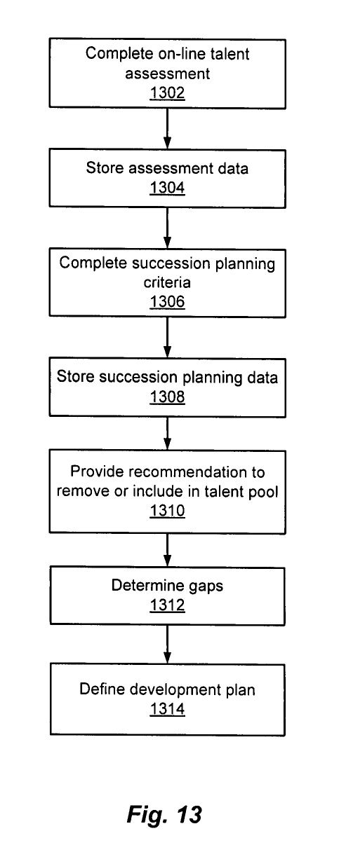

FIG. 13 is a method for performing the talent assessment process. Through EPM's web-based workflow, managers complete the talent assessment form at step 1302. The assessment data is stored in the database at step 1304. They also complete the succession planning criteria presented at step 1306 which is also stored in the database. The manager can then make a recommendation for inclusion in talent pool(s), if that criterion is present, and rate all of the competencies on the assessment form at step 1310. As the manager rates the competencies, a graph showing the competency gaps to the competency model targets for each pool is determined and displayed at step 1312. The manager can then define a development plan for the employee for reducing the gap at step 1314.

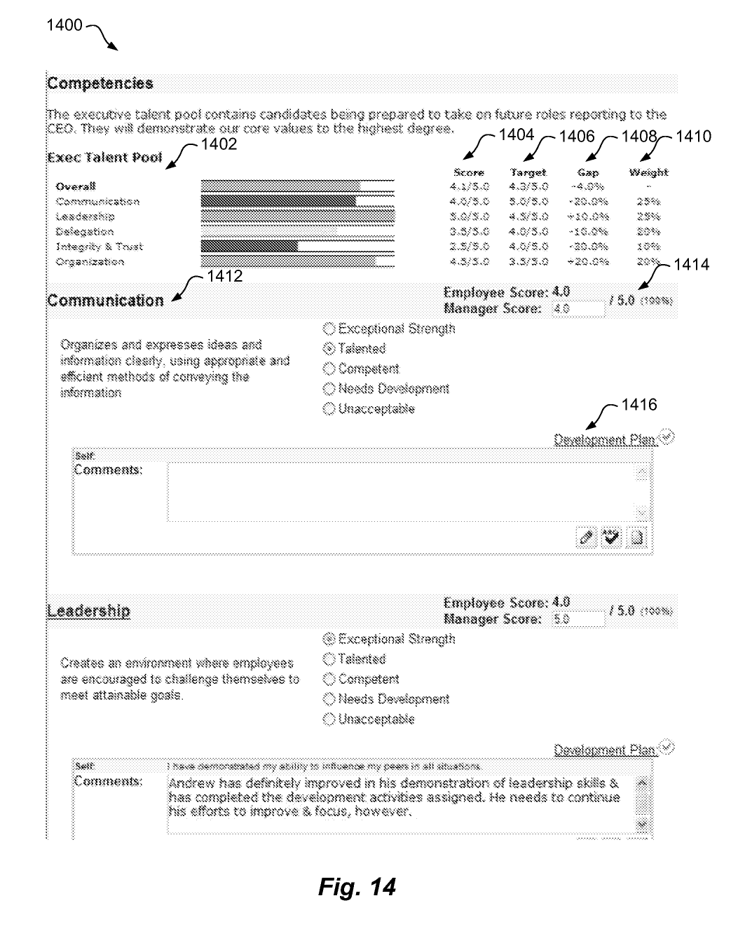

FIG. 14 is an illustration of a talent assessment form 1400 generated by the EPM system. This helps the manager define a development plan for the specific competency where the employee needs to improve. It may also help the manager make recommendations for the person to be removed from the talent pool and/or added to another talent pool. The report shows the succession criteria required for the talent pool 1402 and the rates of the employee against those criteria. The score 1404 is shown in addition to the target for the talent pool criteria 1406. A gap between the two is then displayed 1408 as well as the weight of the competency in the talent pool 1410. Each of the criteria for example communication 1412 can then be displayed in detail with the employees self-score and the managers score 1414 in more detail. The manager also has the opportunity to define the development plan 1416 relative to the criteria.

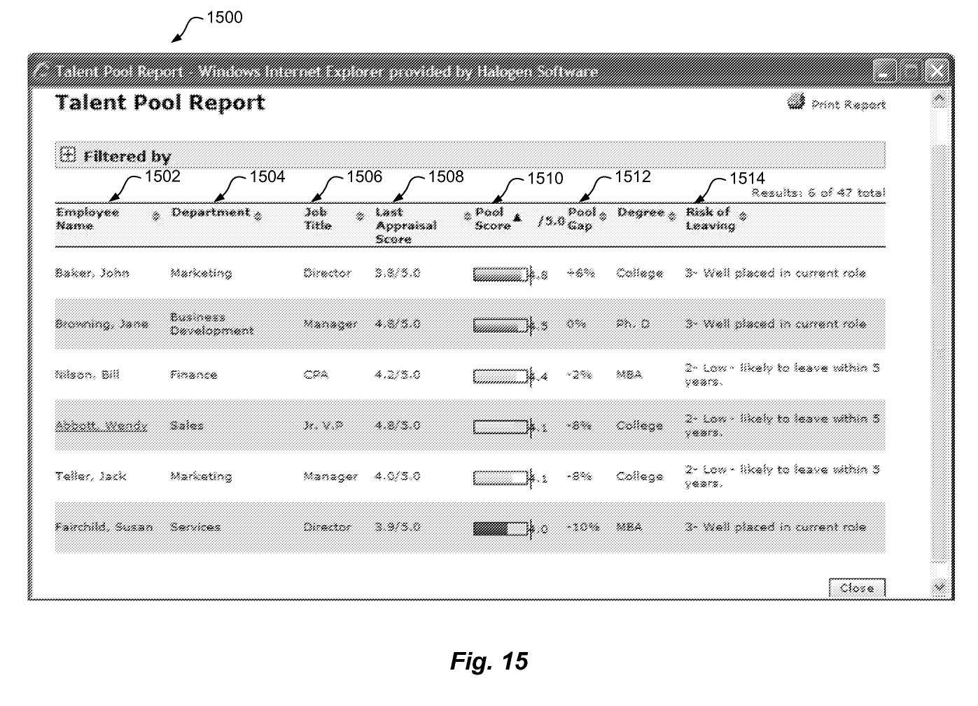

FIG. 15 is an illustration of a talent pool report 1500. Once the talent assessment is complete, HR can review the results. HR uses the Talent Pool, High Potential and Retention Risk reports to help them assess current and potential pool members. The talent pool report displays employee details such as name 1502, department 1504, job title 1506, last appraisal score 1508, pool score 1510, pool gap 1512 and risk of leaving 1514 and other selected info. The pool score can be displayed as a bar graph for each candidate showing talent score and gap to talent pool target score. The bar graph can be color coded to show proximity to talent pool score threshold. The talent score is determined for each candidate by retrieving the talent assessment score for each pool talent criteria and multiplying by criteria weight. In addition to identifying retention risk, this report also includes data for individuals such performance score, potential rating, department, and position. Where there are individuals with high performance and/or potential—it is important to start managing their personal retention risk with career development or other rewards in order to keep that potential on your side.

It will be apparent to persons skilled in the art that a number of variations and modifications can be made without departing from the scope of the invention as defined in the claims.

The method steps may be embodied in sets of executable machine code stored in a variety of formats such as object code or source code. Such code is described generically herein as programming code, or a computer program for simplification. Clearly, the executable machine code or portions of the code may be integrated with the code of other programs, implemented as subroutines, plug-ins, add-ons, software agents, by external program calls, in firmware or by other techniques as known in the art.

The embodiments may be executed by a computer processor or similar device programmed in the manner of method steps, or may be executed by an electronic system which is provided with means for executing these steps. Similarly, an electronic memory medium such computer diskettes, CD-ROMS, Random Access Memory (RAM), Read Only Memory (ROM) or similar computer software storage media known in the art, may be programmed to execute such method steps. As well, electronic signals representing these method steps may also be transmitted via a communication network.

The embodiments described above are intended to be illustrative only. The scope of the invention is therefore intended to be limited solely by the scope of the appended claims.

1. A method for performing web-based succession planning (SP), the method comprising the steps of:
creating a talent pool and associating the talent pool with one or more talent criteria from a pre-defined competency database;
assigning a weight value and a target value for each talent criteria associated to the talent pool;
assigning a gap threshold percentage to the talent pool, wherein the gap threshold defines a differential between a current employee assessment and the talent criteria target value;
assigning succession criteria from a pre-defined succession criteria database list based upon characteristics of a group of employees being assessed;
retrieving assessed talent criteria scores and succession criteria scores for each employee of a group of employees from an employee assessment database;
determining candidates from the group of employees for inclusion in the talent pool based upon the assessed talent criteria score relative to the gap threshold of the talent pool, and the succession criteria scores for each of the employees from an employee assessment database; and
displaying the candidates suitable for inclusion in the talent pool based upon the assessment score and succession criteria scores.

2. The method of claim 1 wherein each weight value is defined as a percentage and a total of the weight values associated with each of the talent criteria is equal to 100 percent.

3. The method of claim 2 wherein the step of determining candidates for the talent pool further comprises the step of identifying gap competencies based upon gap threshold and the assessed criteria

4. The method of claim 3 wherein identifying the gap competencies further comprises the step of utilizing the competency gaps to define a development plan for the candidate employee.

5. The method of claim 1 wherein the talent criteria is selected from the competency database comprising communication, leadership, delegation, integrity & trust and organization.

6. The method of claim 1 wherein the succession criteria is selected from the succession criteria database list comprising potential for promotion, timing for next promotion, risk of leaving, and reason for leaving.

7. The method of claim 1 further comprising the steps of:
adding candidates to the talent pool; and
managing members of the talent pools.

8. The method of claim 1 further comprising the step of acquiring employee assessment data through web page input and storing the data in the employee assessment database.

9. The method of claim 8 further comprising the step of acquiring talent and succession criteria assessment data through web page input and storing the data in the employee assessment database.

10. The method of claim 1 wherein the step of displaying further comprises generating a html webpage to display information pertaining to the suitable candidates.

11. The method of claim 10 wherein generating the html webpage further comprises generating a high potential report by generating a 9×9 grid having an x-axis segmented into three ranges for appraisal scores and a y-axis defining potential for promotion segmented into three tiers wherein the number of candidates associated with one of the tiers of promotion potential in relation to their last appraisal scores are identified in each box of the grid.

12. The method of claim 10 wherein generating the html webpage further comprises generating a risk retention report in an html viewer which identifies factors affecting retention of employees.

13. The method of claim 10 wherein generating the html webpage further comprises generating a talent report identifying employees included in the talent pool wherein the talent report identifies a pool score and a pool gap score.

14. A web-based succession planning system comprising:
a memory for storing databases;
a processor for performing the steps of:
creating a talent pool and associating the talent pool with one or more talent criteria from a pre-defined competency database stored in the memory;
assigning a weight value and a target value for each talent criteria associated to the talent pool;
assigning a gap threshold percentage to the talent pool, wherein the gap threshold defines a differential between a current employee assessment and the talent criteria target value;
assigning succession criteria from a pre-defined succession criteria database list based upon characteristics of a group of employees being assessed;
retrieving assessed talent criteria scores and succession criteria scores for each employee of a group of employees from an employee assessment database stored in the memory;
determining candidates from the group of employees for inclusion in the talent pool based upon the assessed talent criteria score relative to the gap threshold of the talent pool, and the succession criteria scores for each of the employees from an employee assessment database stored in the memory; and
displaying the candidates suitable for inclusion in the talent pool based upon the assessment score and succession criteria scores.

15. The system of claim 14 further comprising the step of acquiring employee assessment data and storing the data in the employee assessment database stored in the memory.

16. The system of claim 15 further comprising the step of acquiring talent and succession criteria assessment data and storing the data in the employee assessment database in the memory.

17. The system of claim 16 further comprising a web server for generating html web pages for data from the database stored in memory.

18. The system of claim 17 wherein the web server generates the html webpage comprising a high potential report by generating a 9×9 grid having an x-axis segmented into three ranges for appraisal scores and a y-axis defining potential for promotion segmented into three tiers wherein the number of candidates associated with one of the tiers of promotion potential in relation to their last appraisal scores are identified in each box of the grid.

19. The system of claim 17 wherein the web server generates the html webpage comprising a risk retention report in an html viewer which identifies factors affecting retention of employees.

20. The system of 17 wherein the web server generates the html webpage comprising a talent report identifying employees included in the talent pool wherein the talent report identifies a pool score and a pool gap score.

21. The system of claim 14 wherein each weight value is defined as a percentage and a total of the weight values associated with each of the talent criteria is equal to 100 percent.

22. The system of claim 21 wherein the step of determining candidates for the talent pool further comprises the step of identifying gap competencies based upon gap threshold and the assessed criteria

23. The system of claim 22 wherein identifying the gap competencies further comprises the step of utilizing the competency gaps to define a development plan for the candidate employee.

24. A computer readable medium containing instructions for performing web-based succession planning (SP), the instructions when executed by a processor perform the steps of:
creating a talent pool and associating the talent pool with one or more talent criteria from a pre-defined competency database;
assigning a weight value and a target value for each talent criteria associated to the talent pool;
assigning a gap threshold percentage to the talent pool, wherein the gap threshold defines a differential between a current employee assessment and the talent criteria target value;
assigning succession criteria from a pre-defined succession criteria database list based upon characteristics of a group of employees being assessed;
retrieving assessed talent criteria scores and succession criteria scores for each employee of a group of employees from an employee assessment database;
determining candidates from the group of employees for inclusion in the talent pool based upon the assessed talent criteria score relative to the gap threshold of the talent pool, and the succession criteria scores for each of the employees from an employee assessment database; and
displaying the candidates suitable for inclusion in the talent pool based upon the assessment score and succession criteria scores.
